(19) United States
(12) Patent Application Publication
(10) Pub. No.: US 2018/0286556 A1
(43) Pub. Date: Oct. 4, 2018

(54) INTEGRATED CIRCUIT IMPLEMENTED INDUCTORS AND METHODS OF MANUFACTURE

(71) Applicant: Intel Corporation, Santa Clara, CA (US)

(72) Inventors: Amit K. Jain, Portland, OR (US); Sameer Shekhar, Portland, OR (US); John T. Vu, Hillsboro, OR (US)

(73) Assignee: Intel Corporation, Santa Clara, CA (US)

(21) Appl. No.: 15/477,080

(22) Filed: Apr. 1, 2017

(51) Int. Cl. H01F 27/02; H01F 41/04; H01F 27/29; H01F 27/06

(52) U.S. Cl. CPC H01F 27/027; H01F 41/041; H01F 2017/002; H01F 27/06; H01F 2027/065; H01F 27/292

(57) ABSTRACT

An inductor of an integrated circuit can include one or more magnetically transparent and non-conductive layers, a plurality of conductive elements, and a plurality of through hole conductor elements. The plurality of conductive elements can be disposed about opposite sides of each of the one or more non-conductive layers. The plurality of through hole conductive elements can be disposed through the one or more non-conductive layers and electrically coupling selected ones of the plurality of conductive elements in one or more conductive paths configured such that a magnetic field generated in response to a current flow in the one or more conductive paths opposes changes in the current flow.

### BACKGROUND

An inductor, also referred to as a coil, choke, or reactor, is a passive device that typically includes an electric conductor wound in a coil. The inductor can store electrical energy in a magnetic field when a current is flowing through the inductor. The magnetic field opposes changes in the flow of current. Inductors are commonly used in alternating current applications, such as radio receivers and transmitters, oscillators, phase lock loops, filters, and the like.

Inductors, however, can be difficult to fabricate in integrated circuits because of their relatively large size and because the magnetic field typically radiates in the integrated circuit and thereby causes electromagnetic interference within the integrated circuit. As such, inductors that can readily be fabricated and used in integrated circuit applications are desirable.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 is a diagram illustrating an inductor for implementation in integrated circuits in accordance with an example;

FIG. 2 is a diagram illustrating an inductor for implementation in integrated circuits in accordance with another example;

FIG. 3 is a flow diagram of a process for fabricating an inductor in accordance with an example;

FIG. 4 is a diagram illustrating an inductor for implementation in integrated circuits in accordance with yet another example;

FIG. 5 is a diagram illustrating an inductor for implementation in integrated circuits in accordance with another example;

FIG. 6 is a diagram illustrating an inductor for implementation in integrated circuits in accordance with another example;

FIG. 7 is a diagram illustrating an inductor for implementation in integrated circuits in accordance with another example; and

FIG. 8 is a diagram illustrating a plurality of inductors for implementation in integrated circuits in accordance with yet another example.

FIG. 9 is a diagram illustrating an inductor implemented in a package of an integrated circuit in accordance with an example; and

FIG. 10 is a diagram illustrating an inductor implemented packaged in an integrated circuit of a system in accordance with an example.

### DESCRIPTION OF EMBODIMENTS

Before invention embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to convey a thorough understanding of various invention embodiments. One skilled in the relevant art will recognize, however, that such detailed embodiments do not limit the overall inventive concepts articulated herein, but are merely representative thereof.

As used in this written description, the singular forms “a,” “an” and “the” include express support for plural referents unless the context clearly dictates otherwise. Thus, for example, reference to “an inductor” includes a plurality of such inductors.

Reference throughout this specification to “an example” means that a particular feature, structure, or characteristic described in connection with the example is included in at least one invention embodiment. Thus, appearances of the phrases “in an example” or “in an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various invention embodiments and examples can be referred to herein along with alternatives for the various components thereof. It is understood that such embodiments, examples, and alternatives are not to be construed as de facto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device, which is more likely to have write errors to it than other regions in the same memory device. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases, depend on the specific context. However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood, that such a range format is used merely for convenience and brevity, and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

As used herein, the term “circuitry” can refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Various techniques, or certain aspects or portions thereof, may take the form of program code (i.e., instructions) embodied in tangible media, such as floppy diskettes, compact disc-read-only memory (CD-ROMs), hard drives, transitory or non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “processor” can include general purpose processors, specialized processors such as central processing units (CPUs), graphics processing units (GPUs), digital signal processors (DSPs), microcontrollers (MCUs), embedded controller (ECs), field programmable gate arrays (FPGAs), or other types of specialized processors, as well as base band processors used in transceivers to send, receive, and process wireless communications.

It should be understood that many of the functional units described in this specification may have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

In one aspect, an integrated circuit implemented inductor can include a first plurality of conductive elements disposed in a metal layer on a first surface of a non-conductive layer. A second plurality of conductive elements can be disposed in a metal layer on a second surface of the first non-conductive layer opposite the first plurality of conductive elements. A third plurality of conductive elements can be disposed through the first non-conductive layer. A first set of the third plurality of conductive elements can be disposed radially from a second set of the third plurality of conductive elements. The first plurality of conductive elements, the second plurality of conductive elements, and the third plurality of conductive elements can be selectively coupled in a first conductive path from sequential alternating ones of the first plurality of conductive elements, the first set of the third conductive elements, the second plurality of conductive elements and the second set of the third conductive elements. The integrated circuit may also include one or more additional non-conductive layers disposed on top of or below the layers of the inductor.

In one aspect, the conductive path can be disposed substantially as a toroidal polyhedron. A magnetic field generated in response to a current flowing in the conductive path can be substantially confined to the toroidal polyhedron.

In another aspect, fabrication of an inductor in an integrated circuit can include depositing a first conductive layer on one or more other layers of an integrated circuit. The first conductive layer can be patterned to form a first plurality of conductive elements. One or more non-conductive layers can be deposited on the first plurality of conductive elements. A plurality of openings can be formed through the one or more non-conductive layers to expose selected portions of each of the first plurality of conductive elements. A second plurality of conductive elements can be deposited in the opening through the one or more non-conductive layers and electrically coupled to the exposed selected portions of each of the first plurality of conductive elements. A second conductive layer can be deposited on an exposed one of the one or more non-conductive layers. The second conductive layer can be patterned to form a third plurality of conductive elements selectively coupled to the second plurality of conductive elements. The first plurality of conductive elements, the second plurality of conductive elements, and the third plurality of conductive elements can be coupled together as a conductive path wrapped about a toroidal polyhedron wherein a first set of the second plurality of conductive elements are disposed about a first perimeter of the toroidal polyhedron and a second set of the second plurality of conductive elements are disposed about a second perimeter of the toroidal polyhedron.

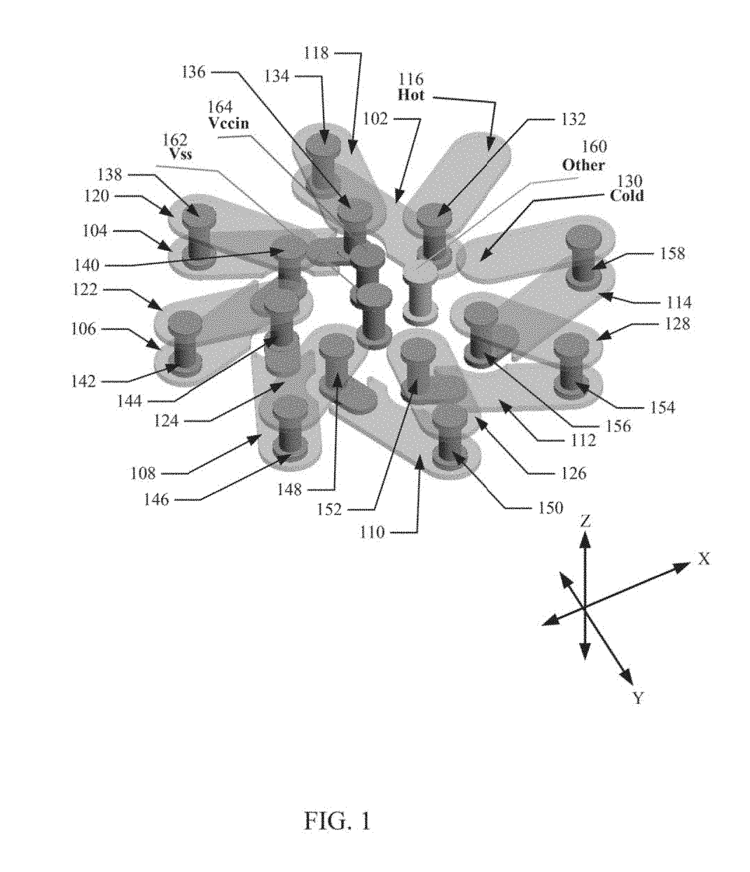

FIG. 1 is a diagram illustrating an inductor for implementation in integrated circuits. In one aspect, the inductor includes one or more non-conductive layers and a number of conductive elements. A first plurality of conductive elements 102-114 can be disposed on a first surface of a first non-conductive layer (not shown). A second plurality of conductive elements 116-130 can be disposed on a second surface of the first non-conductive layer opposite the first plurality of conductive elements 102-114. A third plurality of conductive elements (e.g. vias) 132-158 can be disposed through the first non-conductive layer.

In one aspect, a first set 134, 138, 142, 146, 150, 154, 158 of the third plurality of conductive elements can be disposed radially from a second set 132, 136, 140, 144, 148, 152, 156 of the third plurality of conductive elements. The first plurality of conductive elements 102-114, the second plurality of conductive elements 116-130, and the third plurality of conductive elements 132-158 can be selectively coupled in a first conductive path from sequential alternating ones of the first plurality of conductive elements 102-114, the first set of the third conductive elements 134, 138, 142, 146, 150, 154, 158, the second plurality of conductive elements 116-130, and the second set of the third conductive elements 132, 136, 140, 144, 148, 152, 156.

The conductive elements 102-158 can be coupled together as a conductive path wrapped about a toroidal polyhedron wherein a first set of the second plurality of conductive elements are disposed about a first perimeter of the toroidal polyhedron and a second set of the second plurality of conductive elements are disposed about a second perimeter of the toroidal polyhedron.

The plurality of conductive elements 102-158 can be coupled together in a conductive path configured such that a magnetic field generated in response to a current flow in the conductive path opposes changes in the current flow. The magnetic field can be substantially contained within the toroidal polyhedron bounded by the plurality of conductive elements 102-158.

In one aspect, the inductor may be formed in one or more packaging layers of an integrated circuit. For example, an interconnect passivation layer may be used as the non-conductive layer, a first interconnect metalization layer may also form the first plurality of conductive elements, and a second interconnect metalization layer may also form the second plurality of conductive elements of the inductor. Similarly, the inductor may be formed in one or more die layers of an integrated circuit. For example, an insulative layer may be used as the non-conductive layer, a first semiconductor layer or metal layer may also form the first plurality of conductive elements, and a second semiconductor layer or metal layer may also form the second plurality of conductive layers. Accordingly, the same layers used to make interconnections across a die, between dies in a multi-chip package, between a die and external contacts, or the like, and processes from forming those layers, can be utilized for the inductor.

In one aspect, the inductor can further include one or more additional conductive elements 160-164 disposed through the first non-conductive layer in the area surrounded by the toroidal polyhedron. The additional conductive elements 160-164 can be used for routing signals and or supply potentials because the magnetic flux is substantially contained within the toroidal polyhedron and not in the area inside the toroidal polyhedron.

A plurality of the above described structures can be coupled together to comprise the inductor. For instance, the inductor can further include a fourth plurality of conductive elements disposed on a first surface of a second non-conductive layer. A fifth plurality of conductive elements can be disposed on a second surface of the second non-conductive layer opposite fourth plurality of conductive elements. A sixth plurality of conductive elements can be disposed through the second non-conductive layer. Again, a first set of the sixth plurality of conductive elements can be disposed radially from a second set of the sixth plurality of conductive elements. Likewise, the fourth plurality of conductive elements, the fifth plurality of conductive elements, and the sixth plurality of conductive elements can be selectively coupled in a second conductive path from sequential alternating ones of the fourth plurality of conductive elements, the first set of the sixth conductive elements, the fifth plurality of conductive elements and the second set of the sixth conductive elements. The second conductive path can be electrically coupled in series or in parallel to the first conductive path. For example, the “cold” conductive element 130 of one portion of the inductor 102-158 can be electrically coupled by one or more traces, vias or the like of the integrated circuit to the “hot” conductive element of the other portion of the inductor. In another example, the “hot” conductive element 116 of one portion of the inductor 102-158 can be electrically coupled to the “hot” conductive element of the other portion of the inductor, and the “cold” conductive element 130 of the portion of the inductor 102-158 can be electrically coupled to the “cold” conductive element of the other portion of the inductor.

The portion of the inductor formed from the first non-conductive layer, and the first, second and third plurality of conductive elements may be separated from the portion of the inductor formed from the second non-conductive layer, and the fourth, fifth and sixth plurality of conductive elements by one or more additional non-conductive layers, and optionally one or more additional conductive layers of the integrated circuit. For example, one portion of the inductor 102-158 may be formed in a plurality of layers toward a first side (e.g., top) of the integrated circuit package and the other portion of the inductor may be formed in a plurality of layers toward a second side (e.g., bottom) of the integrated circuit package.

In a first alternative, the fourth plurality of conductive elements can be disposed on the first surface of the first non-conductive layer. The fifth plurality of conductive elements can be disposed on the second surface of the first non-conductive layer. The sixth plurality of conductive elements can be disposed through the first non-conductive layer. Accordingly, both portions of the inductor are formed in the same layers, disposed laterally from each other, in the integrated circuit. This may be advantageous when the layout and routing in an integrated circuit is easier utilizing an inductor comprising two portions instead of a single large inductor.

In a second alternative, the fourth plurality of conductive elements can be disposed between the first surface of the first non-conductive layer and a first surface of a second non-conductive layer. The fifth plurality of conductive elements can be disposed on a second surface of the second non-conductive layer opposite the fourth plurality of conductive elements. The sixth plurality of conductive elements can be disposed through the second non-conductive layer. Accordingly, the first and fourth plurality of conductive elements can be formed from the same metal layer sandwiched between the first and second non-conductive layers. Furthermore, it is to be appreciated that an inductor can be similarly laid out with the third and fourth plurality of conductive elements formed from the same metal layer.

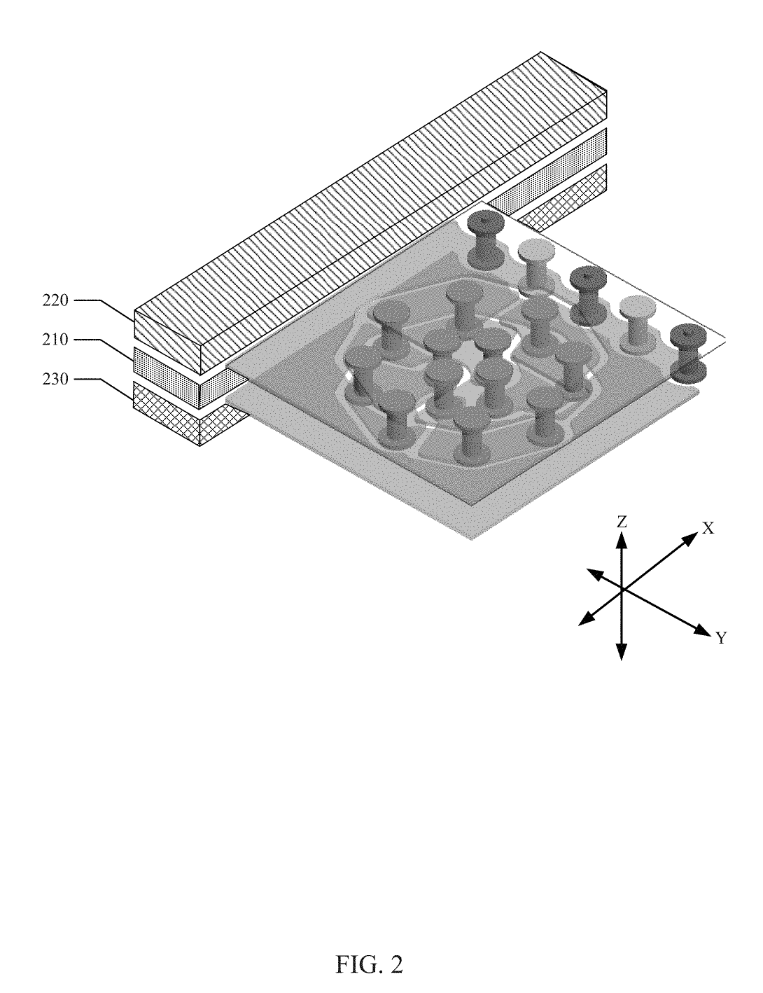

As illustrated in FIG. 1, the width of each of the first and second plurality of conductive elements may be substantially uniform in the radial direction. Alternatively, the width of each of the first and/or second plurality of conductive elements may increase in the radial direction, and the spacing between adjacent ones of the first plurality of conductive elements and/or adjacent ones of the second plurality of conductive elements in the radial direction can be substantially equal, as illustrated in FIG. 2. Utilizing the first and/or second plurality of conductive elements having width that increase in the radial direction such that the spacing between adjacent ones of the conductive elements is substantially equal in the radial direction can increase the confinement of the magnetic flux within the toroidal polyhedron bounded by the conductive path formed by the first, second and third plurality of conductive elements.

In addition, each one of the third plurality of conductive elements may electrically couple respective ones of the first and second plurality of conductive elements, as illustrated in FIG. 1. Alternatively, a set of two or more of the third plurality of conductive elements may electrically couple select respective ones of the first and second plurality of conductive elements along the outer perimeter of the toroidal polyhedron as illustrated in FIG. 2. The number and spacing of the third plurality of conductive elements coupling select respective one of the first and second plurality of conductive elements along the outer perimeter of the toroidal polyhedron may be based upon the minimum feature size of the third plurality of conductive elements, and/or the alignment accuracy between the third plurality of conductive elements and the first and second plurality of conductive elements. Utilizing a set of two or more of the plurality of conductive elements to electrically couple select respective ones of the first and second plurality of conductive elements along the outer perimeter of the toroidal polyhedron can increase the confinement of the magnetic flux within the toroidal polyhedron bounded by the conductive path formed by the first, second and third plurality of conductive elements. Furthermore, a set of two or more of the plurality of conductive elements electrically coupling select respective ones of the first and second plurality of conductive elements along the outer perimeter of the toroidal polyhedron can decrease the resistance through the conductive path. Similarly, the use of first and/or second plurality of conductive elements having increasing widths in the radial direction can also decrease the resistance through the conductive path.

FIG. 2 also illustrates the first non-conductive layer 210 disposed between the first and second plurality of conductive elements. In addition, the inductor may include one or more non-conductive layers 220, 230 disposed on top of and/or below the layers of the inductor.

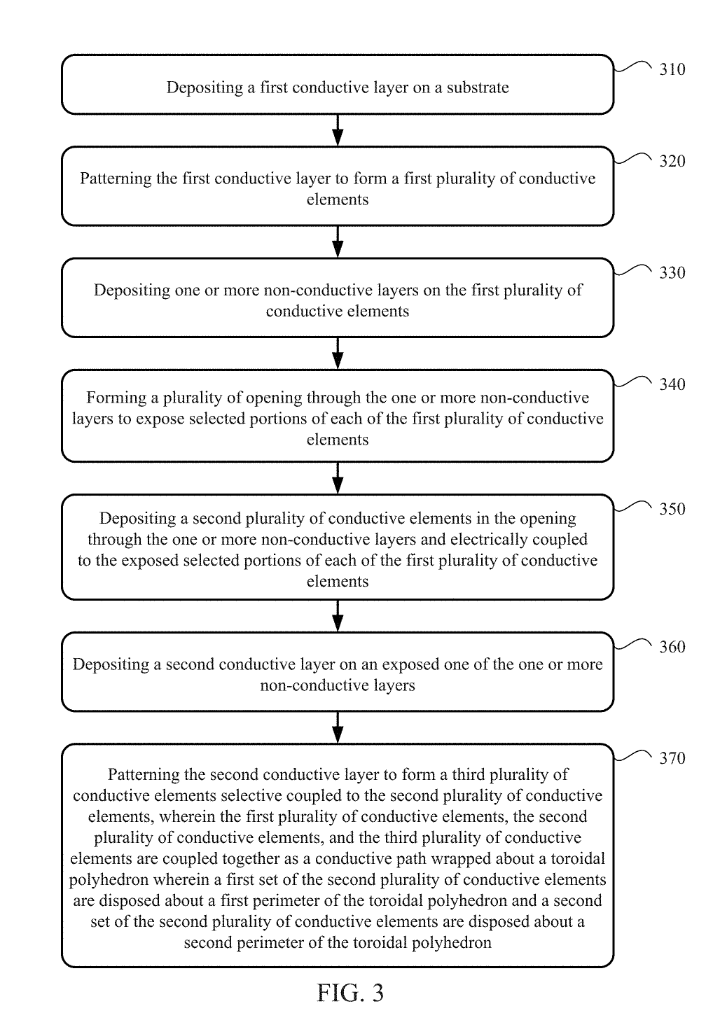

FIG. 3 is a flow diagram of a method for fabricating an inductor in accordance with an example. The method can include depositing a first conductive layer on one or more layers of an integrated circuit 310. The one or more layers of the integrated circuit can include one or more layers of a die package, one or more layers of a chip package, or a combination thereof. For example, the first conductive layer may be a metal interconnect layer deposited on a glass or plastic inter-level dielectric layer. The first conductive layer can be deposited on the substrate by processes such as sputtering, platting, chemical vapor deposition, and/or the like to form a first metal layer.

The first conductive layer can be patterned to form a first plurality of conductive elements 320. The first plurality of conductive elements can be patterned by processes such as photolithography and selective etching, and/or the like. Alternatively, the plurality of conductive elements may be formed by processes such as photolithography and ion implantation in a chip substrate. It is to be appreciated that the first conductive layer can also be patterned to form one or more other conductive elements of the integrated circuit die and/or integrated circuit package, such as package interconnects, contacts, and/or the like.

One or more non-conductive layers can be deposited on the first plurality of conductive elements 330. The one or more non-conductive layers can be deposited by processes such as film deposition and/or the like. The one or more non-conductive layers may be magnetically transparent. In one example, a thin or thick film of glass or plastic in a liquid state may be spun on and allowed to harden to form a non-conductive layer.

A plurality of openings through the one or more non-conductive layers can be formed to expose selected portions of each of the first plurality of conductive elements 340. The plurality of opening can be formed by processes such as photolithography and selective etching. In one example, a plurality of through holes may be laser etched in the one or more conductive layers.

A second plurality of conductive elements can be deposited in the opening through the one or more non-conductive layers and electrically coupled to the exposed selected portions of each of the first plurality of conductive elements 350. The second plurality of conductive elements can be deposited by processes such as photolithography, sputtering, platting, chemical vapor deposition, selective etching, and/or the like. In one example, a metal may be plated on the surface of the integrated circuit such that it fills the through holes. The excess metal may then be etched thereby forming plated through hole vias.

A second conductive layer can be deposited on the integrated circuit 360. The second conductive layer can be deposited on the substrate by processes such as sputtering, platting, chemical vapor deposition, and/or the like to form a second metal layer.

The second conductive layer can be patterned to form a third plurality of conductive elements selectively coupled to the second plurality of conductive elements 370. The first plurality of conductive elements can be patterned by processes such as photolithography and selective etching, and/or the like. Again, it is to be appreciated that the second conductive layer can also be patterned to form one or more other conductive elements of the die chip and/or package, such as package interconnects, contacts, and/or the like.

The first plurality of conductive elements, the second plurality of conductive elements, and the third plurality of conductive elements can be coupled together as a conductive path wrapped about a toroidal polyhedron wherein a first set of the second plurality of conductive elements are disposed about a first perimeter of the toroidal polyhedron and a second set of the second plurality of conductive elements are disposed about a second perimeter of the toroidal polyhedron.

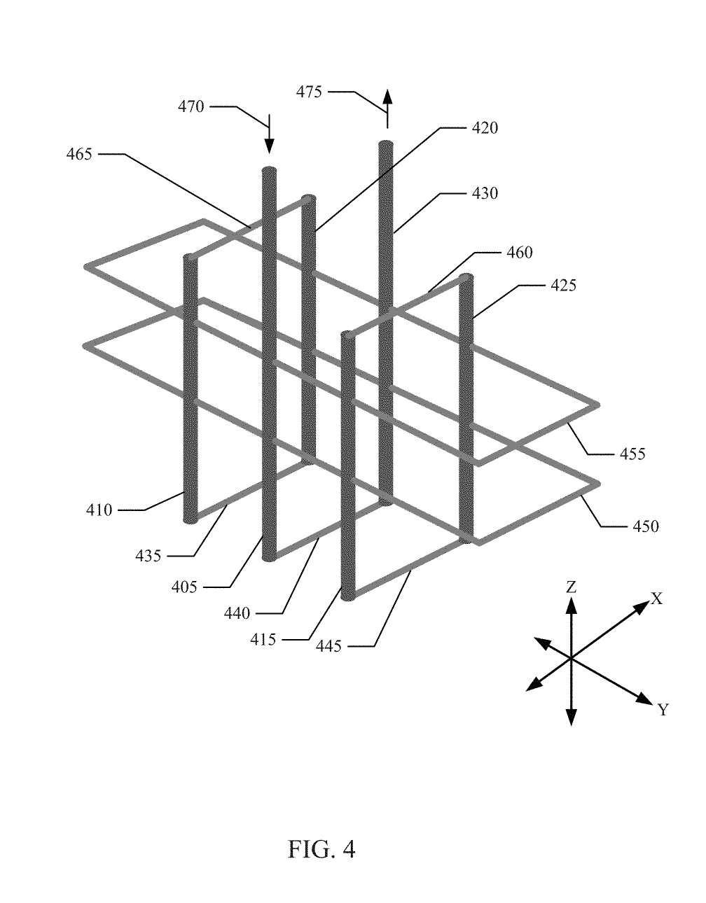

In the examples of FIGS. 1 and 2, the magnetic field in the inductor would be orientated in the x-y plane (e.g., a lateral plane in the integrated circuit die or package). However, the inductor may be arranged so that the magnetic field is orientated in the y-z or x-z plane (e.g., a vertical plane of the integrated circuit die or chip package). FIG. 4 is a diagram illustrating an inductor for implementation in integrated circuits in accordance with yet another example. The inductor is arranged with through hole vias 405-430 orientated with the z-axis, and traces 435-465 orientated in the x-y plane to form a conductive path. One or more of the traces orientated in the x-y plane may be formed as closed loop traces 450, 455, within a respective metal layer that are coupled to select through hole vias, while other traces 435-445, 460, 465 may simply be coupled to select through hole vias. A magnetic field generated by currents 470-475 flowing in the conductive path can be substantially confined within the conductive path and will rotate within the y-z plane.

In one aspect, the inductors in accordance with embodiments of the present technology can be fabricated within an integrated circuit die, using a plurality of semiconductor and/or metal layers, and one or more passivation layers of the integrated circuit die. In another aspect, the inductors in accordance with embodiments of the present technology can be fabricated within an integrated circuit package, using a plurality of metal interconnect layers, and one or more passivation layers of the integrated circuit package. In another aspect, the inductors in accordance with embodiments of the present technology can be fabricated between the integrated circuit die and package, using one or more metal interconnect layers of the integrated circuit die, one or more passivation layers of the integrated circuit die or package, and one or more metal interconnect layers of the integrated circuit package. In another aspect, the inductors in accordance with embodiments of the present technology can be fabricated between the integrated circuit package and a printed circuit board (PCB) (e.g., motherboard) using one or more metal interconnect layers of the integrated circuit package, one or more passivation layers of the integrated circuit package or the PCB, and one or more metal interconnect layers of the PCB. In such instances, connections between the one or more metal interconnect layers of the integrated circuit package and the one or more metal interconnect layers of the PCB may, for example, be made by a plurality of solder balls or package connection pins. In yet another aspect, the inductors in accordance with embodiments of the present technology can be fabricated between integrated circuit dies in a multichip package using one or more metal interconnect layers of a first integrated circuit die, one or more passivation layers of the first or a second integrated circuit die, and one or more metal interconnect layers of the second integrated circuit die. In such instances, connections between the one or more metal interconnect layers of the first and second integrated circuit die may, for example, be made by a plurality of solder balls or micro-bumps.

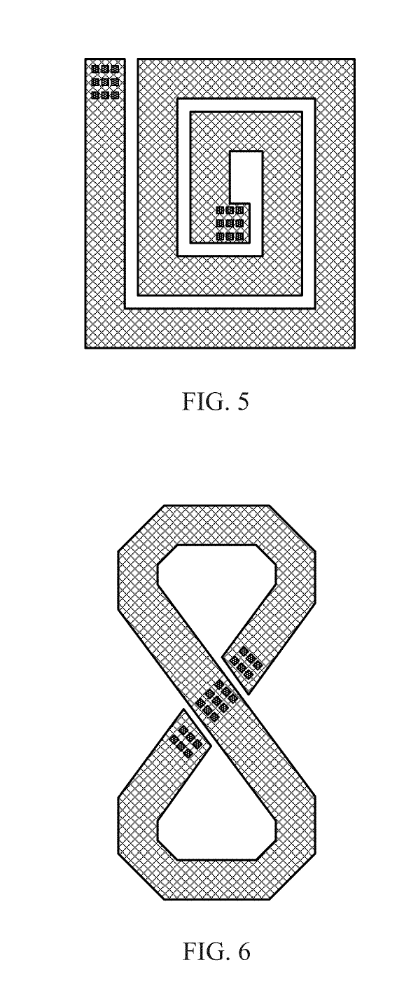

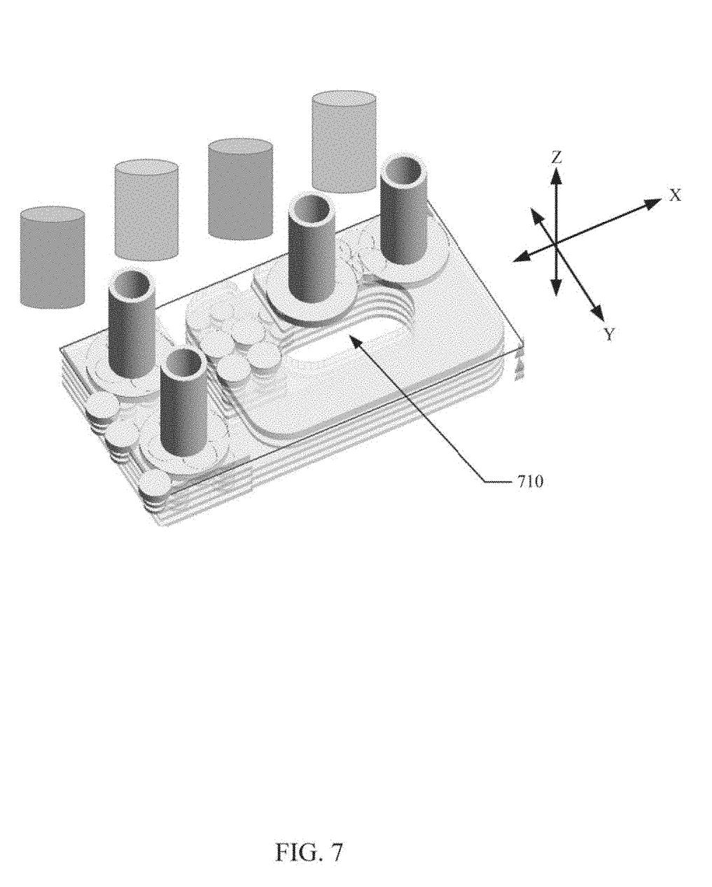

FIGS. 5, 6 and 7 illustrate a spiral type inductor, a figure-eight type inductor, and a race-track type inductor, respectively. In spiral, figure-eight, race track and other similar types of inductors used in integrated circuit device, there is a substantially amount of flux leakage from the inductor. In a race track type inductor the magnetic field may come up through the hole 710 in the center (z-axis) and wrap around (y-axis and x-axis) the outside to come back up through the hole. The field outside the hole in the center of the race track type inductor generates a leakage field that can cause interference. The magnetic field in the z-axis direction results in a need for increased separation from metal layers above and/or below the race track type inductor. Furthermore, when multiple race track type inductors are place laterally adjacent to each other, the magnetic field in the y-axis direction of each race track inductor reinforces each other. Therefore, increased separation from metal layers alongside the race track type inductor is needed. In contrast, the magnetic field of inductors in accordance with embodiments of the present technology is substantially confined within the toroidal polyhedron within the conductive path of the inductors. Therefore, less vertical (z-axis) and lateral separation (x and y-axis) is needed between the inductors in accordance with embodiment of the present technology and adjacent traces, vias, rails, planes and the like.

In an exemplary simulation of an inductor in accordance with embodiments of the present technology and a race track type inductor, there is reduced coupling to external circuits. For example, in a 200 μm package core, with vertical metalization layers (e.g., laser through hole vias) spaced at the minimum allowed distance, the magnetic coupling from the race track type inductor to a noise sensitive conductor such as an input supply voltage plane of a data transfer interface may be approximately 25 pH. In contrast, the inductor in accordance with embodiments of the present technology implemented with the same package features may have a mutual inductance of 2 pH with the input supply voltage plane of a data transfer interface circuit. Therefore, in comparison to a 30 mVₚₚ noise coupling quantified for the rack track type inductor, the noise coupling for an inductor in accordance with embodiments of the present technology would be less than approximately 3 mVₚₚ. The reduced magnetic coupling could enable a higher data transfer speed bin without the overhead otherwise needed to reduce magnetic coupling from a race track type inductor to sensitive conductors such as power rails and shielding grounds.

Inductors in accordance with embodiments of the present technology are advantageously characterized by a higher inductance, a lower resistance, higher quality factor (Q), smaller area and/or lower height as compared to substantially similar spiral type inductors, figure-eight type inductors, and race-track inductors. For example, an inductance in accordance with embodiments of the present technology and a similar race track type inductor may have inductance, resistance, Q factor, area and height parameters as set forth in Table 1:

TABLE 1

| | Present Technology | |
|---|---|---|
| Topology | Inductor | Race Track Inductor |
| L [nH] | 0.901 | 1.068 |
| R [mΩ] | 59.7 | 76.2 |
| Q | 9.9 | 8.7 |
| Area [mm²] | 1.56 | 1.81 |
| Height [μm] | 270 | 355 |

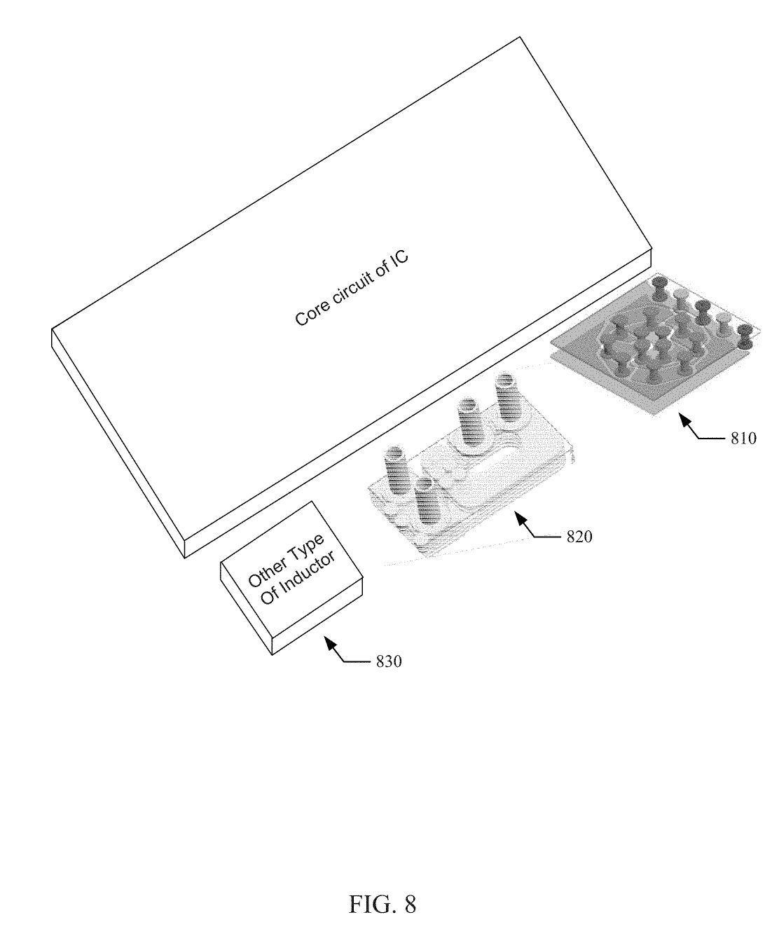

It is also to be appreciated that the inductor in accordance with embodiments of the present technology 810 may be utilized in an integrated circuit in combination with one or more other types of inductors, including but not limited to coil type inductors, figure eight type inductors, race-track type inductors 820, and/or other similar type inductors 830, as illustrated in FIG. 8. Inductors in accordance with embodiments of the present technology can advantageous be realized in the core layers of the package, thereby freeing up backside layers for other signal and/or supply routing. For example, input voltage routing to a voltage regulator may be routed using one or more backside layers that pass across the inductor. In other instances, a race track type inductor can be used in areas of the integrated circuit that are not sensitive to magnetic coupling where the race track type inductor can be advantageously fabricated layers toward the top or bottom of the integrated circuit.

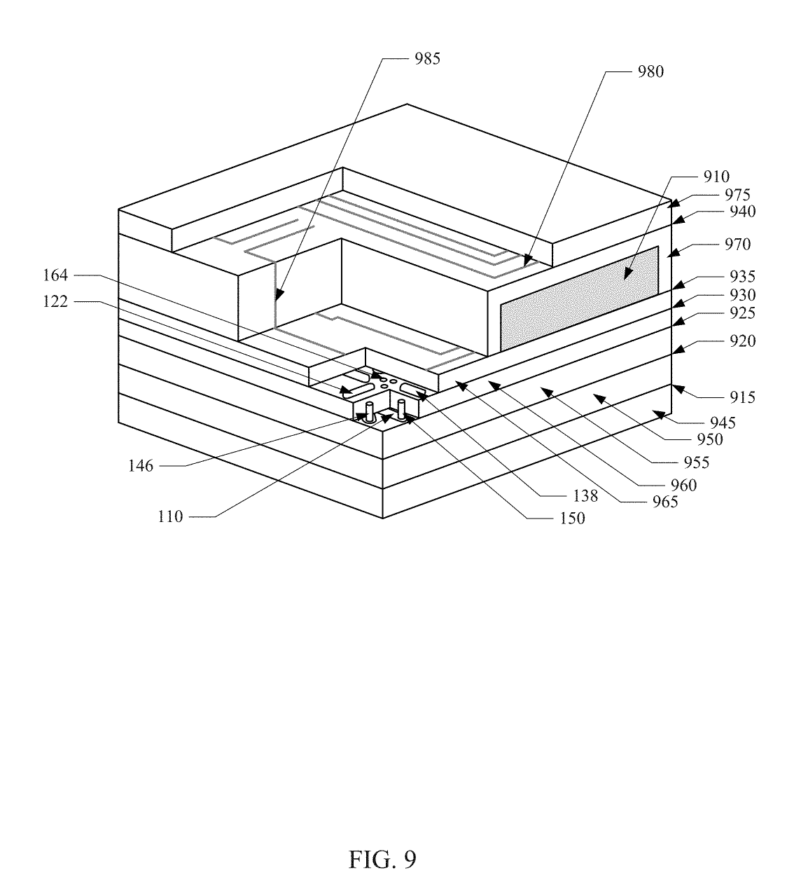

FIG. 9 illustrates an inductor implemented in a package of an integrated circuit in accordance with an example. The integrated circuit package can include an integrated circuit die 910 and a plurality of packaging layers. The packaging layers can include a plurality of metal layers 915-940, and a plurality interlevel dielectric layers 940-975. The plurality of metal layers 915-940 may include one or more conductive planes, and/or one or more layers of conductive traces 980 for making electrical connections between the die 910 and external contacts (not shown) on the package. In addition, the package includes a plurality of conductive vias 985 through various interlevel dielectric layers 940-975 to make electrical connections between various traces 980, conductive planes, and external contacts.

Portions of various metal layers 925-940 and interlevel dielectric layers 965-975 are shown cutaway to illustrate an inductor in accordance with embodiments of the present technology 110-164, die 910, and conductive traces 980 and vias 985. The inductor can include a plurality of conductive elements 110, 122, 138, disposed in a first and a second metal layer 925, 930, an interlevel dielectric layer 960, and a third plurality of conductive elements 146, 150, disposed through the interlevel dielectric layer 960. The first, second and third plurality of conductive elements 110, 122, 138, 146, 150 can be selectively coupled in a conductive path wrapped about a toroidal polyhedron to form the inductor as described in more detail above with regard to FIGS. 1-3. In addition, one or more conductive elements 164 can be disposed through the interior of the toroidal polyhedron for additional routing of signals and or supply potentials, as also described above in more detail.

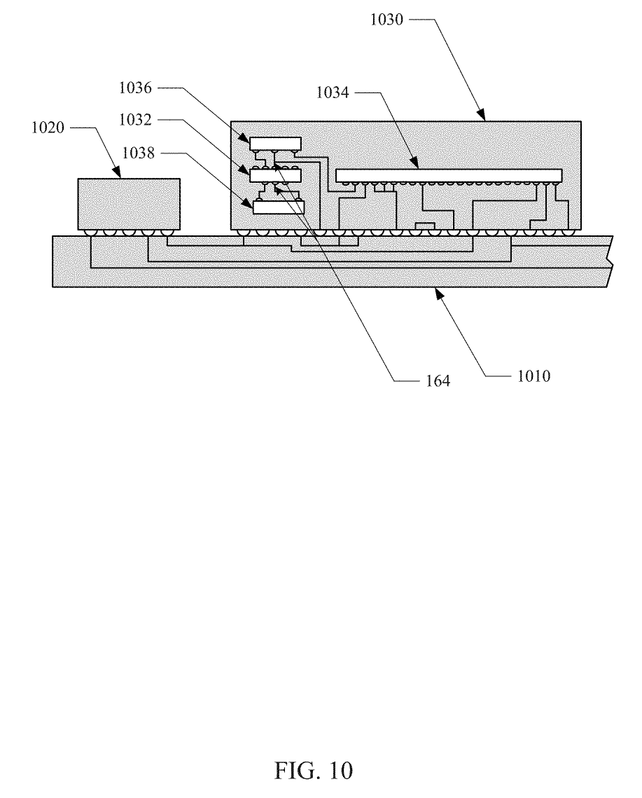

FIG. 10 illustrates an inductor implemented packaged in an integrated circuit of a system in accordance with an example. The system can include a motherboard 1010, a plurality of integrated circuit packages 1020, 1030, and optionally one or more discrete components (not shown). One or more integrated circuit packages can include an inductor 1032 in accordance with embodiments of the present technology. For instance, the integrated circuit package 1030 can include a core integrated circuit die 1034, an inductor 1032, and a plurality of traces, vias and contacts for making electrically connections therebetween. In addition, the integrated circuit package 1030 can optionally one or more other integrated circuit die 1036 and or components 1038. In one example, the core integrated circuit die 1034 may be a memory array such as a double data rate random access memory (DDR RAM) die for use in a computer, smartphone or other similar system. The package of the DDR RAM may also include a voltage regulator 1036, one or more inductors 1032 in accordance with embodiments of the present technology, one or more capacitor 1038, and various other sub-circuits and components. In another example, the core integrated circuit die 1034 may be a Radio Frequency (RF) transceiver for use in router, smartphone or other similar system. The package of the RF transceiver may also include one or more inductors 1032 in accordance with embodiments of the present technology, one or more capacitor 1038, and various other sub-circuits and components.

The inductor 1032 in accordance with embodiments of the present technology may be fabricated in a plurality of conductive layers and interlayer dielectric layers of the integrated circuit package along with the core integrated circuit die 1034 and other optional sub-circuits and components. For instance, the inductor 1032 can include a plurality of conductive elements disposed in a first and a second metal layer, an interlevel dielectric layer disposed between the first and second metal layers, and a third plurality of conductive elements disposed through the interlevel dielectric layer. The first, second and third plurality of conductive elements can be selectively coupled in a conductive path wrapped about a toroidal polyhedron to form the inductor 1032 as described in more detail above with regard to FIGS. 1-3. In addition, one or more conductive elements 164 can be disposed through the interior of the toroidal polyhedron of the inductor 1030 for additional routing of signals and or supply potentials, as also described above in more detail.

Embodiments of the present technology advantageously reduce the magnetic flux leakage that could impinge on conductors in areas vertically and horizontally adjacent the inductor. Embodiments of the present technology can advantageously enable routing in areas vertically and horizontally adjacent to the inductor as well as through the inductor, and therefore may reduce system height of the integrated circuit.

### EXAMPLES

The following examples pertain to specific technology embodiments and point out specific features, elements, or steps that may be used or otherwise combined in achieving such embodiments.

In one example, there is provide an integrated circuit comprising:

a first non-conductive layer;

a first plurality of conductive elements disposed on a first surface of the first non-conductive layer;

a second plurality of conductive elements disposed on a second surface of the first non-conductive layer opposite the first plurality of conductive elements; and

a third plurality of conductive elements disposed through the first non-conductive layer, wherein a first set of the third plurality of conductive elements are disposed radially from a second set of the third plurality of conductive elements, and wherein the first plurality of conductive elements, the second plurality of conductive elements, and the third plurality of conductive elements are selectively coupled in a first conductive path from sequential alternating ones of the first plurality of conductive elements, the first set of the third conductive elements, the second plurality of conductive elements and the second set of the third conductive elements.

In one example of an in integrated circuit, an interconnect passivation layer includes the non-conductive layer, a first interconnect metalization layer includes the first plurality of conductive elements, and a second interconnect metalization layer include the second plurality of conductive elements.

In one example of an in integrated circuit, a semiconductor layer includes the first plurality of conductive elements, a first insulative layer includes the non-conductive layer, and a first metal layer includes the second plurality of conductive elements.

In one example of an in integrated circuit, the non-conductive layer includes a glass film.

In one example of an in integrated circuit, the non-conductive layer includes a plastic film.

In one example of an in integrated circuit, the non-conductive layer is magnetically transparent.

In one example of an in integrated circuit, the conductive path is disposed substantially as a toroidal polyhedron.

In one example of an in integrated circuit, a magnetic field generated in response to a current flow in the conductive path is substantially confined to the toroidal polyhedron.

In one example of an in integrated circuit, the circuit further includes one or more additional conductive elements disposed through the first non-conductive layer in an area surrounded by the toroidal polyhedron.

In one example of an in integrated circuit, the circuit further comprises:

a second non-conductive layer;

a fourth plurality of conductive elements disposed on a first surface of the second non-conductive layer;

a fifth plurality of conductive elements disposed on a second surface of the second non-conductive layer opposite the fourth plurality of conductive elements; and

a sixth plurality of conductive elements disposed through the second non-conductive layer, wherein a first set of the sixth plurality of conductive elements are disposed radially from a second set of the sixth plurality of conductive elements, and wherein the fourth plurality of conductive elements, the fifth plurality of conductive elements, and the sixth plurality of conductive elements are selectively coupled in a second conductive path from sequential alternating ones of the fourth plurality of conductive elements, the first set of the sixth conductive elements, the fifth plurality of conductive elements and the second set of the sixth conductive elements; and

wherein the second conductive path is electrically coupled in series or parallel to the first conductive path.

In one example there is provided, an electronic device comprising:

one or more non-conductive layers;

a plurality of conductive elements disposed about opposite sides of each of the one or more non-conductive layers; and

a plurality of through hole conductive elements disposed through the one or more non-conductive layers and electrically coupling selected ones of the plurality of conductive elements in one or more conductive paths configured such that a magnetic field generated in response to a current flow in the one or more conductive paths opposes changes in the current flow.

In one example of a device, the plurality of through hole conductive elements include a first set of through hole conductive elements disposed in a radial direction from the first set of through hole conductive elements.

In one example of a device, a width of each of the plurality of conductive elements is substantially uniform in the radial direction.

In one example of a device, a width of each of the plurality of conductive elements increases in the radial direction, and a spacing between adjacent ones of the plurality of conductive elements in the radially direction is substantially equal.

In one example of a device, the magnetic field is substantially contained within a toroidal polyhedron bounded by the plurality of conductive elements and the plurality of through hole conductive elements.

In one example of a device, the magnetic field substantially contained within the toroidal polyhedron is orientated in an x-y plane of the device.

In one example of a device, the magnetic field substantially contained within the toroidal polyhedron is orientated in an y-z plane of the device.

In one example of a device, the one or more non-conductive layers correspond to one or more passivation layers of an integrated circuit die, and the plurality of conductive elements are disposed in one or more semiconductor or metal layers of an integrated circuit die.

In one example of a device, the one or more non-conductive layers correspond to one or more passivation layers of an integrated circuit package and the plurality of conductive elements are disposed in one or more metal layers of an integrated circuit package.

In one example of a device, the plurality of conductive elements include:

a first conductive layer an in integrated circuit package; and

a second conductive layer in a printed circuit board (PCB), wherein the second conductive layer is electrically coupled to the first conductive layer by a plurality of solder balls or package connection pins.

In one example of a device, the plurality of conductive elements include:

a first conductive layer in a first integrated circuit; and

a second conductive layer a second integrated circuit, wherein the first and second integrated circuits are electrically coupled to together in a package by a plurality of solder balls or micro-bumps.

In one example of a device, one or more of the plurality of conductive elements comprise closed loop traces.

In one example there is provided a method of manufacturing an inductor comprising:

depositing a first conductive layer on one or more other layers of an integrated circuit;

patterning the first conductive layer to form a first plurality of conductive elements;

depositing one or more non-conductive layers on the first plurality of conductive elements;

forming a plurality of openings through the one or more non-conductive layers to expose selected portions of each of the first plurality of conductive elements;

depositing a second plurality of conductive elements in the opening through the one or more non-conductive layers and electrically coupled to the exposed selected portions of each of the first plurality of conductive elements;

depositing a second conductive layer on an exposed one of the one or more non-conductive layers;

patterning the second conductive layer to form a third plurality of conductive elements selectively coupled to the second plurality of conductive elements; and

wherein the first plurality of conductive elements, the second plurality of conductive elements, and the third plurality of conductive elements are coupled together as a conductive path wrapped about a toroidal polyhedron wherein a first set of the second plurality of conductive elements are disposed about a first perimeter of the toroidal polyhedron and a second set of the second plurality of conductive elements are disposed about a second perimeter of the toroidal polyhedron.

In one example of a method of making an inductor, the one or more layers of the integrated circuit comprise an integrated circuit die, the first conductive layer is further patterned to form one or more other conductive elements of the integrated circuit die, and the second conductive layer is further patterned to form one or more additional conductive elements of the integrated circuit die.

In one example of a method of making an inductor, the one or more layers of the integrated circuit comprise an integrated circuit package, the first conductive layer is further patterned to form one or more other conductive elements of the integrated circuit package and the second conductive layer is further patterned to form one or more additional conductive elements of the integrated circuit package.

In one example of a method of making an inductor, the one or more layers of the integrated circuit comprises an integrated circuit die, the first conductive layer is further patterned to form one or more other conductive elements of the integrated circuit die, and the second conductive layer is further patterned to form one or more additional conductive elements of the integrated circuit package.

In one example of a method of making an inductor, the one or more non-conductive layers include one or more glass film layers, the first conductive layer includes a first metal layer, and the second conductive layer includes a second metal layer.

In one example, there is provided an integrated circuit comprising:

a first inductor including,

a first non-conductive layer;

a first plurality of conductive elements disposed on a first surface of the first non-conductive layer;

a second plurality of conductive elements disposed on a second surface of the first non-conductive layer opposite the first plurality of conductive elements; and

a third plurality of conductive elements disposed through the first non-conductive layer, wherein the first plurality of conductive elements, the second plurality of conductive elements, and the third plurality of conductive elements are selectively coupled in a first conductive path bounding a toroidal polyhedron portion of the first non-conductive layer from sequential alternating ones of the first plurality of conductive elements, the first set of the third conductive elements, the second plurality of conductive elements and the second set of the third conductive elements; and

a second inductor of a spiral type inductor, a figure-eight type inductor or a race track type inductor.

In one example of an integrated circuit, a magnetic field generated in response to a current flow in the conductive path of the first inductor is substantially confined to the toroidal polyhedron.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology.

What is claimed is:

1. An integrated circuit comprising:
a first non-conductive layer;
a first plurality of conductive elements disposed on a first surface of the first non-conductive layer;
a second plurality of conductive elements disposed on a second surface of the first non-conductive layer opposite the first plurality of conductive elements; and
a third plurality of conductive elements disposed through the first non-conductive layer, wherein a first set of the third plurality of conductive elements are disposed radially from a second set of the third plurality of conductive elements, and wherein the first plurality of conductive elements, the second plurality of conductive elements, and the third plurality of conductive elements are selectively coupled in a first conductive path from sequential alternating ones of the first plurality of conductive elements, the first set of the third conductive elements, the second plurality of conductive elements and the second set of the third conductive elements.

2. The integrated circuit according to claim 1, wherein,
an interconnect passivation layer includes the non-conductive layer;
a first interconnect metalization layer includes the first plurality of conductive elements; and
a second interconnect metalization layer include the second plurality of conductive elements.

3. The integrated circuit according to claim 1, wherein
a semiconductor layer includes the first plurality of conductive elements;
a first insulative layer includes the non-conductive layer; and
a first metal layer includes the second plurality of conductive elements.

4. The integrated circuit according to claim 1, wherein the non-conductive layer includes a glass film.

5. The integrated circuit according to claim 1, wherein the non-conductive layer includes a plastic film.

6. The integrated circuit according to claim 1, wherein the non-conductive layer is magnetically transparent.

7. The integrated circuit according to claim 1, wherein the conductive path is disposed substantially as a toroidal polyhedron.

8. The integrated circuit according to claim 7, wherein a magnetic field generated in response to a current flow in the conductive path is substantially confined to the toroidal polyhedron.

9. The integrated circuit according to claim 7, further including one or more additional conductive elements disposed through the first non-conductive layer in an area surrounded by the toroidal polyhedron.

10. The integrated circuit according to claim 1, further comprising:
a second non-conductive layer;
a fourth plurality of conductive elements disposed on a first surface of the second non-conductive layer;
a fifth plurality of conductive elements disposed on a second surface of the second non-conductive layer opposite the fourth plurality of conductive elements; and
a sixth plurality of conductive elements disposed through the second non-conductive layer, wherein a first set of the sixth plurality of conductive elements are disposed radially from a second set of the sixth plurality of conductive elements, and wherein the fourth plurality of conductive elements, the fifth plurality of conductive elements, and the sixth plurality of conductive elements are selectively coupled in a second conductive path from sequential alternating ones of the fourth plurality of conductive elements, the first set of the sixth conductive elements, the fifth plurality of conductive elements and the second set of the sixth conductive elements; and
wherein the second conductive path is electrically coupled in series or parallel to the first conductive path.

11. An electronic device comprising:
one or more non-conductive layers;
a plurality of conductive elements disposed about opposite sides of each of the one or more non-conductive layers; and
a plurality of through hole conductive elements disposed through the one or more non-conductive layers and electrically coupling selected ones of the plurality of conductive elements in one or more conductive paths configured such that a magnetic field generated in response to a current flow in the one or more conductive paths opposes changes in the current flow.

12. The device according to claim 11, wherein the plurality of through hole conductive elements include a first set of through hole conductive elements disposed in a radial direction from the first set of through hole conductive elements.

13. The device according to claim 12, wherein a width of each of the plurality of conductive elements is substantially uniform in the radial direction.

14. The device according to claim 12, wherein a width of each of the plurality of conductive elements increases in the radial direction, and a spacing between adjacent ones of the plurality of conductive elements in the radially direction is substantially equal.

15. The device according to claim 11, wherein the magnetic field is substantially contained within a toroidal polyhedron bounded by the plurality of conductive elements and the plurality of through hole conductive elements.

16. The device according to claim 15, wherein the magnetic field substantially contained within the toroidal polyhedron is orientated in an x-y plane of the device.

17. The device according to claim 15, wherein the magnetic field substantially contained within the toroidal polyhedron is orientated in an y-z plane of the device.

18. The device according to claim 11, wherein,
the one or more non-conductive layers correspond to one or more passivation layers of an integrated circuit die; and
the plurality of conductive elements are disposed in one or more semiconductor or metal layers of an integrated circuit die.

19. The device according to claim 11, wherein,
the one or more non-conductive layers correspond to one or more passivation layers of an integrated circuit package; and
the plurality of conductive elements are disposed in one or more metal layers of an integrated circuit package.

20. The device according to claim 11, wherein the plurality of conductive elements include:
a first conductive layer an in integrated circuit package; and
a second conductive layer in a printed circuit board (PCB), wherein the second conductive layer is electrically coupled to the first conductive layer by a plurality of solder balls or package connection pins.

21. The device according to claim 11, wherein the plurality of conductive elements include:
a first conductive layer in a first integrated circuit; and
a second conductive layer a second integrated circuit, wherein the first and second integrated circuits are electrically coupled to together in a package by a plurality of solder balls or micro-bumps.

22. The device according to claim 11, wherein one or more of the plurality of conductive elements comprise closed loop traces.

23. A method of manufacture comprising:
depositing a first conductive layer on one or more other layers of an integrated circuit;
patterning the first conductive layer to form a first plurality of conductive elements;
depositing one or more non-conductive layers on the first plurality of conductive elements;
forming a plurality of openings through the one or more non-conductive layers to expose selected portions of each of the first plurality of conductive elements;
depositing a second plurality of conductive elements in the opening through the one or more non-conductive layers and electrically coupled to the exposed selected portions of each of the first plurality of conductive elements;
depositing a second conductive layer on an exposed one of the one or more non-conductive layers;
patterning the second conductive layer to form a third plurality of conductive elements selectively coupled to the second plurality of conductive elements; and
wherein the first plurality of conductive elements, the second plurality of conductive elements, and the third plurality of conductive elements are coupled together as a conductive path wrapped about a toroidal polyhedron wherein a first set of the second plurality of conductive elements are disposed about a first perimeter of the toroidal polyhedron and a second set of the second plurality of conductive elements are disposed about a second perimeter of the toroidal polyhedron.

24. The method of manufacturing according to claim 23, wherein,
the one or more layers of the integrated circuit comprise an integrated circuit die;
the first conductive layer is further patterned to form one or more other conductive elements of the integrated circuit die; and
the second conductive layer is further patterned to form one or more additional conductive elements of the integrated circuit die.

25. The method of manufacturing according to claim 23, wherein,
the one or more layers of the integrated circuit comprise an integrated circuit package;
the first conductive layer is further patterned to form one or more other conductive elements of the integrated circuit package; and
the second conductive layer is further patterned to form one or more additional conductive elements of the integrated circuit package.

26. The method of manufacturing according to claim 23, wherein,
the one or more layers of the integrated circuit comprises an integrated circuit die;
the first conductive layer is further patterned to form one or more other conductive elements of the integrated circuit die; and
the second conductive layer is further patterned to form one or more additional conductive elements of the integrated circuit package.

27. The method of manufacturing according to claim 23, wherein
the one or more non-conductive layers include one or more glass film layers;
the first conductive layer includes a first metal layer; and
the second conductive layer includes a second metal layer.

28. An integrated circuit comprising:
a first inductor including,
a first non-conductive layer;
a first plurality of conductive elements disposed on a first surface of the first non-conductive layer;
a second plurality of conductive elements disposed on a second surface of the first non-conductive layer opposite the first plurality of conductive elements; and
a third plurality of conductive elements disposed through the first non-conductive layer, wherein the first plurality of conductive elements, the second plurality of conductive elements, and the third plurality of conductive elements are selectively coupled in a first conductive path bounding a toroidal polyhedron portion of the first non-conductive layer from sequential alternating ones of the first plurality of conductive elements, the first set of the third conductive elements, the second plurality of conductive elements and the second set of the third conductive elements; and
a second inductor of a spiral type inductor, a figure-eight type inductor or a race track type inductor.

29. The integrated circuit according to claim 28, wherein a magnetic field generated in response to a current flow in the conductive path of the first inductor is substantially confined to the toroidal polyhedron.
